(19) United States
(12) Patent Application Publication
(10) Pub. No.: US 2024/0135702 A1
(43) Pub. Date: Apr. 25, 2024

(54) SYSTEMS AND METHODS FOR GEOREGISTRATION SERVICE FOR VIDEO

(71) Applicant: Palantir Technologies Inc., Denver, CO (US)

(72) Inventors: Ethan Van Andel, Berkeley, CA (US); Miles Sackler, Seattle, WA (US); Mueed Ur Rehman, Jersey City, NJ (US); Qinfeng Chen, Jericho, NY (US)

(73) Assignee: Palantir Technologies Inc., Denver, CO (US)

(21) Appl. No.: 18/226,618

(22) Filed: Jul. 25, 2023

Related U.S. Application Data
(60) Provisional application No. 63/417,883, filed on Oct. 20, 2022.
(60) Provisional application No. 63/441,487, filed on Jan. 27, 2023.

(51) Int. Cl. G06V 20/13; G06T 7/80; H04N 7/01

(52) U.S. Cl. CPC G06V 20/13; G06T 7/80; H04N 7/013; H04N 7/0135

(57) ABSTRACT

Systems and methods for video georegistration are provided. An example method includes receiving an input video including a plurality of video frames; calibrating a first set of video frames selected from the plurality of video frames to generate a first set of calibrated video frames using a calibration transform; and performing one or more reference georegistrations to a second set of video frames selected from the plurality of video frames to generate a video georegistration transform using the second set of video frames. The second set of video frames have fewer video frames than the first set of video frames. The method further includes generating an output video using the calibration transform and the video georegistration transform.

### CROSS REFERENCE TO RELATED APPLICATIONS

This application claims priority to U.S. Provisional Application Nos. 63/441,487 and 63/417,883, both entitled “SYSTEMS AND METHODS FOR GEOREGISTRATION SERVICE FOR VIDEO,” filed on Jan. 27, 2023 and Oct. 20, 2022, respectively, which are incorporated by reference herein for all purposes in their entirety.

### TECHNICAL FIELD

Certain embodiments of the present disclosure relate to georegistration services for video. More particularly, some embodiments of the present disclosure relate to aligning received video with one or more reference images.

### BACKGROUND

Georegistration is a process for aligning two or more images or datasets spatially to a common coordinate system. In some examples, georegistration involves finding a transformation that maps points in one image or dataset to corresponding points in another image or dataset. In certain examples, georegistration services for images and/or videos face numerous challenges, including visual variations between images and/or videos, minimal structured content in the images/videos, noise, rotation changes, scale changes, and/or perspective changes between images/videos.

Hence, it is desirable to improve techniques for performing georegistration for videos.

### SUMMARY

Certain embodiments of the present disclosure relate to georegistration. More particularly, some embodiments of the present disclosure relate to performing reference georegistration using one or more reference images.

At least some aspects of the present disclosure are directed to a method for video georegistration. The method includes: receiving an input video including a plurality of video frames; calibrating a first set of video frames selected from the plurality of video frames to generate a first set of calibrated video frames using a calibration transform; and performing one or more reference georegistrations to a second set of video frames selected from the plurality of video frames to generate a video georegistration transform using the second set of video frames. The second set of video frames having fewer video frames than the first set of video frames. The method further includes generating an output video using the calibration transform and the video georegistration transform, wherein the method is performed using one or more processors.

At least some aspects of the present disclosure are directed to a method for video georegistration. The method includes: receiving an input video including a plurality of video frames; and performing one or more reference georegistrations using one or more corresponding reference images at a dynamic frame rate, wherein the method is performed using one or more processors.

At least some aspects of the present disclosure are directed to a system for video georegistration. The system includes: one or more processors; and one or more memories storing instructions that, when executed by the processor, cause the system to perform a set of operations. The set of operations include: receiving an input video including a plurality of video frames; calibrating a first set of video frames selected from the plurality of video frames to generate a first set of calibrated video frames using a calibration transform; and performing one or more reference georegistrations to a second set of video frames selected from the plurality of video frames to generate a video georegistration transform using the second set of video frames. The second set of video frames have fewer video frames than the first set of video frames. The set of operations further include generating an output video using the calibration transform and the video georegistration transform.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 illustrates an example diagram for a video georegistration system, according to certain embodiments of the present disclosure.

FIG. 2 illustrates a simplified diagram showing a software architecture for a video georegistration system, according to certain embodiments of the present disclosure.

FIG. 3 illustrates a simplified diagram showing a method for video georegistration, according to certain embodiments of the present disclosure.

FIG. 4 illustrates simplified diagram showing a method for generating a transformation, according to certain embodiments of the present disclosure.

FIG. 5 illustrates an example of a video georegistration environment, according to certain embodiments of the present disclosure.

FIG. 6 illustrates a simplified diagram showing a computing system for implementing a system for video georegistration, according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods are often not capable of effectively addressing visual variations of images/videos, such as lighting changes, temporal changes (e.g., seasonal changes), sensor mode (e.g., electro-optical (EO), infrared (IR), synthetic-aperture radar (SAR), etc.). Additionally and/or alternatively, conventional systems and methods typically cannot perform georegistration on images/videos with minimal structured content (e.g., forest, fields, water, etc.). Further, images/videos may have noise and/or changes in rotation, scale, and/or perspective which conventional systems and methods typically are unable to address.

Various embodiments of the present disclosure can achieve benefits and/or improvements by a computing system implementing one or more reference georegistrations using one or more corresponding reference images. For example, mechanisms provided herein may perform calibration to generate an output video, in combination with a video georegistration transform. Additionally and/or alternatively, mechanisms provided herein may perform reference georegistration at a dynamic frame rate (e.g., as opposed to a fixed frame rate). In some embodiments, benefits include the ability to perform georegistration on input video that conventional systems or methods were previously unable to effectively perform georegistration thereon. In some embodiments, benefits include calibration processes with lightweight computational costs to enable improved georegistration. Generally, georegistration performed according to mechanisms provided herein is more accurate than conventional mechanisms, such as by using high-quality control points, appropriate transformation models, effective calibration to minimize error, and other processes that may be understood by those of ordinary skill in the art, at least in light of teaching provided herein.

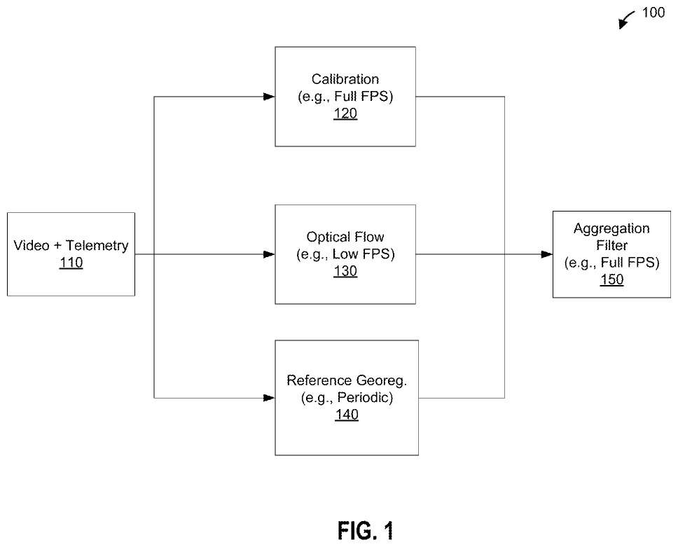

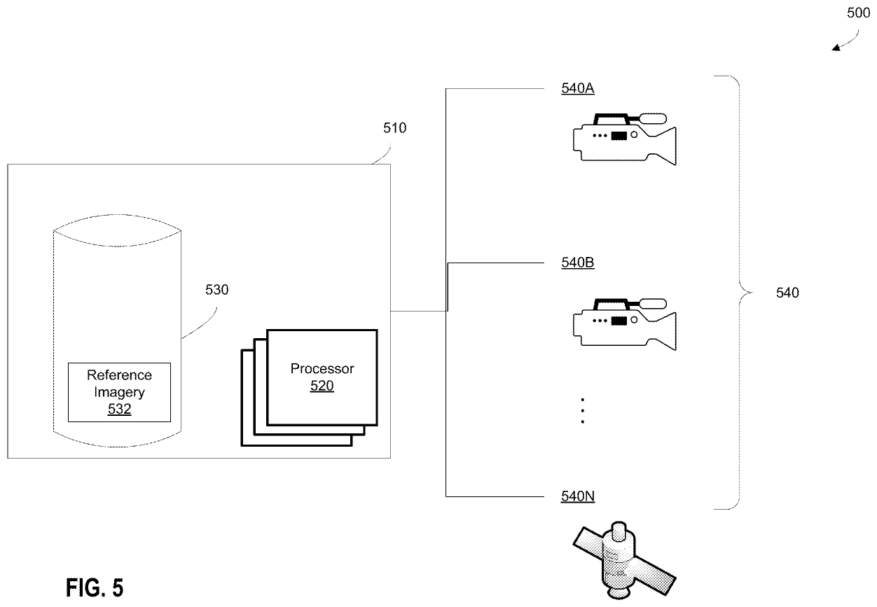

As an example, in some embodiments, input video may be received from one or more satellites (e.g., input video 110 of FIG. 1 may be received from satellites or imaging systems 540 of FIG. 5 discussed later herein). In some embodiments, the videos are received at a georegistration system 710 that includes one or more stored reference images (e.g., reference image 532 of FIG. 5). The reference image (e.g., an image of a coast, city, or other geographic location) may be associated with geographic coordinates and/or the input video (e.g., also containing one or more images of the coast, city, or other geographic location) may be associated with geographic coordinates.

In some embodiments, the input video may be calibrated, such as based on historical telemetry data of input videos or baked-in corrections (e.g., based on lenses or sensors of the satellite from which the input video is received). The historical telemetry data and/or baked-in corrections may be used to generate a calibration transform that is applied to the input video to calibrate the input video (e.g., such that the image of the coast, city, or other geographic location appears more like it realistically should appear).

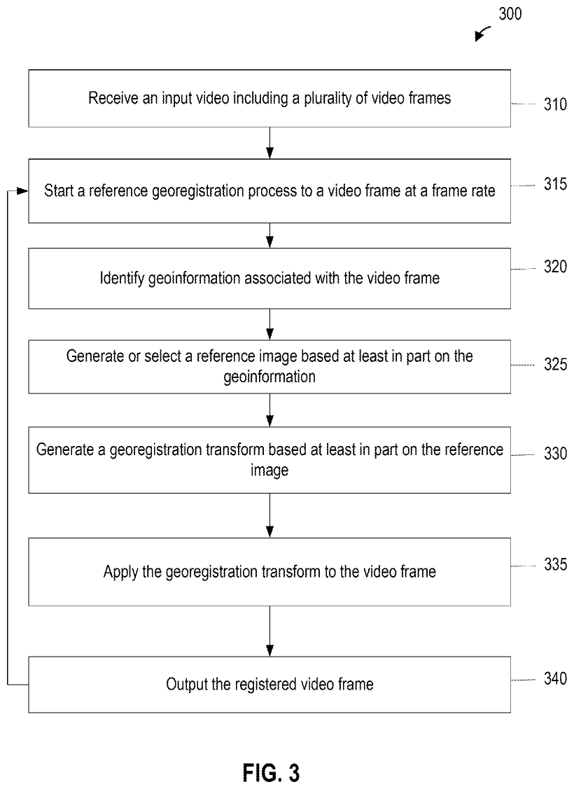

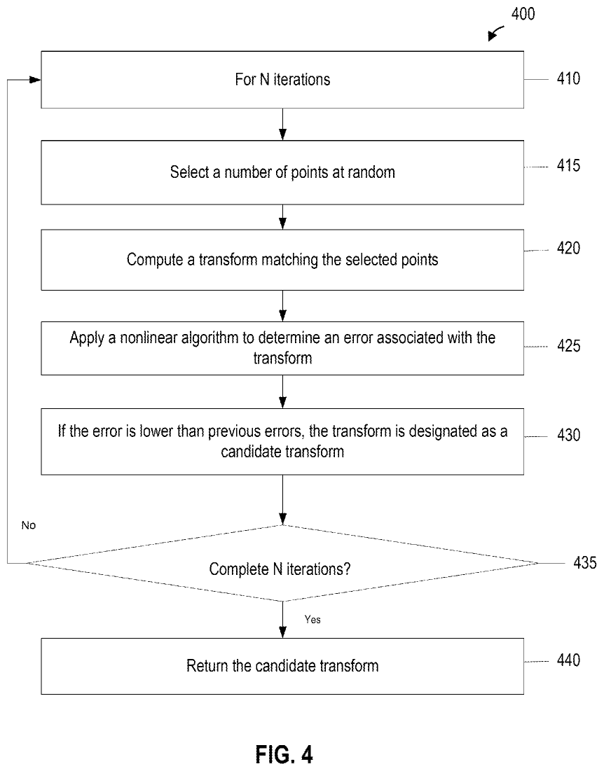

In some embodiments, a plurality of templates or selected derivations may be generated from the input video, for example, such that points (e.g., as discussed at process 415 of FIG. 4) of the plurality of templates correspond to pixel locations of the input video. Each point (e.g., selected using Harris Corner detection algorithm or another key feature detection algorithm) may have a likelihood of match success for matching with a corresponding location on the reference image. For example, a top of a building shown in the input video may be a candidate point that matches to the top of the same building shown in the reference image. Accordingly, the georegistration system may compute a georegistration transform, such as using the Levenberg-Marquardt nonlinear algorithm, or another error reduction algorithm, to reduce error between corresponding pixels/vectors of the reference image and input video. In some embodiments, the georegistration transform matches the largest number of points (e.g., candidate points or lattice points) from the reference image to points on the input video (e.g., on frames of the input video). In some embodiments, the georegistration transform may allow for points between the reference image and input video to be lined-up to generate a registered video frame (e.g., as discussed at process 340 of FIG. 3).

Therefore, according to some embodiments of the present disclosure, satellite videos may be lined up with reference images to generate registered video frames that are of higher quality than conventional georegistration systems, and that allow for accurate visual processing of aerial/geographic videos. The registered video frames may be viewable by a user, such as on one or more displays of a computing device, or output for subsequent processing. Additional and/or alternative examples of mechanisms provided herein will be recognized by those of ordinary skill in the art, in light of the present disclosure.

At least some embodiments of the present disclosure are directed to systems and methods for georegistration for videos, including full motion videos. In certain embodiments, the georegistration system (e.g., a georegistration service) is configured to receive (e.g., obtain) a video from a video recording platform with location information (e.g., telemetry data) and align the received video with a reference frame (e.g., a dynamic reference frame, a reference image, a map) so the georegistration system can determine the geospatial coordinates, also referred to as geo-coordinates, of the video.

In some examples, georegistration, also known as image registration or geometric registration, is a process for aligning two or more images or datasets spatially to a common coordinate system. In certain examples, georegistration involves finding a transformation that maps points in one image or dataset to corresponding points in another image or dataset. Accordingly, in some examples, a goal of georegistration is to accurately overlay and align images or datasets so that they can be compared, analyzed, or combined effectively.

In certain embodiments, georectification refers to assigning geo-coordinates to an image. In some embodiments, orthorectification refers to warping an image to match the top-down view. In certain examples, orthorectification includes reshaping hillsides and such so it looks like the image was taken directly from overhead rather than at a side angle. In some embodiments, georegistration refers to refining the geo-coordinates of a video, for example, based on reference data. In certain embodiments, image registration (e.g., georegistration) refers to, given an input image and one or more reference images, finding a transform mapping the input image to the corresponding part of the one or more reference images. In some embodiments, video registration (e.g., georegistration) refers to, given an input video and one or more reference images, finding a transform or a sequence of transforms mapping the input video including one or more video frames to the corresponding part of the one or more reference images and use the transforms to generate the registered video. In certain embodiments, image/video georegistration has one or more challenges: 1) images/videos have visual variations, for example, lighting changes, temporal changes (e.g., seasonal changes), sensor mode (e.g., electro-optical (EO), infrared (IR), synthetic-aperture radar (SAR), etc.); 2) images/videos have minimal structured content (e.g., forest, fields, water, etc.); 3) images/videos have noise (e.g., image noise for SAR images); and 4) images/videos have rotation, scale, and/or perspective changes.

According to some embodiments, the georegistration system is configured to receive a video (e.g., a streaming video) and choose video frames (e.g., video images) and selected derivations (e.g., derived composites of multiple video frames, a pixel grid of a video frame, etc.) in video frames, also referred to as templates (e.g., 60 by 60 pixels). In certain embodiments, a video georegistration uses selected video frames (e.g., every one second) and templates can be less time-consuming. In some embodiments, the georegistration system performs georegistration of the templates, collects desirable matches, computes image transformation and generates a sequence of registered video frames (e.g., georegistered video frames) and a registered video (e.g., georegistered video).

According to certain embodiments, the georegistration system computes an image representation (e.g., one or more feature descriptors) of the templates for georegistration. In some embodiments, the georegistration system computes the angle weighted oriented gradients (AWOG) representation of the templates for georegistration. In certain embodiments, the georegistration system compares the AWOG representation of the template with reference imagery (e.g., reference image) to determine a match and/or a match score, for example, the template sufficiently matched (e.g., 100%, 80%) the reference imagery. In some embodiments, the georegistration system reiterates the process to find enough matched templates. According to certain embodiments, the georegistration system uses the matched templates to perform georegistration of the image or the video frame. In some embodiments, the matched templates might be noisy and/or irregular.

According to some embodiments, video georegistration is accomplished by a collection of individual components of a georegistration system. In certain embodiments, each of these is an individual AIP (artificial intelligence (AI) inference platform) (e.g., a model orchestrator) processor (e.g., a computing unit implementing AIP), running in parallel and/or behind an aggregation filter processor (e.g., a computing unit implementing AIP). In some embodiments, a processor refers to a computing unit implementing a model (e.g., a computational model, an algorithm, an AI model, etc.). In certain embodiments, a model, also referred to as a computing model, includes a model to process data. A model includes, for example, an AI model, a machine learning (ML) model, a deep learning (DL) model, an image processing model, an algorithm, a rule, other computing models, and/or a combination thereof.

FIG. 1 is an illustrative diagram for a video georegistration system 100. FIG. 1 is merely an example. One of the ordinary skilled in the art would recognize many variations, alternatives, and modifications. For example, some of the components may be expanded, integrated, and/or combined. Other components may be inserted into those noted above. Depending upon the embodiment, the arrangement of components may be interchanged with others replaced. Further details of these components are found throughout the present disclosure.

According to certain embodiments, the video georegistration system 100 includes a video and telemetry component 110, a calibration processor 120, an optical flow processor 120, a reference georegistration processor 140, and/or an aggregation filter processor 150. In some embodiments, the georegistration system 100 receives feedback or performs multiple stages of filtering so that, for instance, the pre-reference-georegistration estimate (e.g., the best pre-reference-georegistration estimate) can be used to seed the reference georegistration. In certain embodiments, the different components in the georegistration system 100 are expected to run at different FPS (frames-per-second) values, based on their computational demands. In some embodiments, the video and telemetry component 110 receives videos with geo-coordinates information. In certain embodiments, the video and telemetry component 110 can extract geo-coordinates information from videos (e.g., videos with telemetry overlay).

According to certain embodiments, the georegistration system 100 and/or the calibration processor 120 can perform calibration to video frames at a selected FPS. In some embodiments, the calibration processor 120 can perform calibration to video frames at full FPS, for example, each video frame is calibrated. In certain embodiments, the calibration processor 120 uses historical telemetry data (e.g., past telemetry) and/or any corrections (e.g., baked-in corrections). In some embodiments, the calibration processor 120 requires lightweight computational cost (e.g., a few milliseconds, a couple of milliseconds).

According to some embodiments, the optical flow processor 130 processes video frames at a low FPS (e.g., 5 FPS, adaptive FPS). In certain embodiments, the georegistration system 100 and/or the optical flow processor 130 computes an optical-flow-based motion model to provide an alternative, smoothed estimate of the motion of one or more objects in the video. In some embodiments, depending on performance profiles, the georegistration system 100 moves the computational kernel for the optical-flow processor 130 into a specific library (e.g., a C++ library). In certain embodiments, DEM (digital elevation model) or similar data model (e.g., digital terrain model) is needed to translate visual motion to estimated physical motion. In some embodiments, the optical-flow processor requires middleweight computational cost (e.g., tens of milliseconds or more). In certain embodiments, the optical-flow processor extracts relative motions of objects from video frames to make corrections.

According to certain embodiments, the reference georegistration processor 140 does reference georegistration periodically (e.g., 1 FPS or less). In some embodiments, the reference georegistration processor registers 140 selected video frames or some derived composite against reference imagery. In certain embodiments, the georegistration system 100 and/or the reference georegistration processor 140 may use the video frame itself or use compositing multiple frames to get more data. In some embodiments, the georegistration system 100 and/or the reference georegistration processor 140 may compare against overhead reference imagery or pre-project the reference or input imagery based on the predicted look angle. In certain embodiments, the georegistration system 100 and/or the reference georegistration processor 140 may use various algorithms (e.g., class of algorithm) including, for example, algorithms to support multimodal (e.g., EO (electro-optical) and IR (infrared)) results. In some embodiments, depending on performance profiles, the georegistration system 100 moves the computational kernel for the reference georegistration processor 140 into a specific library (e.g., a C++ library).

In some embodiments, the reference georegistration processor 140 requires heavyweight computational cost (e.g., less than 1 second). In certain embodiments, the calibration processor 120 processes video frames at a first frame rate (e.g., once every frame, once every other frame, once every J frames). In some embodiments, the optical flow processor 130 processes video frames at a second frame rate (e.g., once every M frames). In certain embodiments, the reference georegistration processor 140 processes video frames at a third frame rate (e.g., once every N frames). In some embodiments, the first frame rate is higher than the second frame rate. In certain embodiments, the second frame rate is higher than the third frame rate. In some embodiments, J<M<N, for the frame rates.

According to certain embodiments, the reference georegistration processor 140 processes video frames for reference georegistration at a dynamic frame rate. In some embodiments, the reference georegistration processor 140 performs georegistration at a first frame rate at a first time. In certain embodiments, the reference georegistration processor 140 performs georegistration at a second frame rate at a second time, where the first frame rate is different from the second frame rate. In some embodiments, the reference georegistration processor 140 is configured to perform georegistration when there are available processing resources (e.g., computing processing unit (CPU), graphics processing unit (GPU)).

According to some embodiments, the aggregation filter processor 150 can process video frames at a full FPS (e.g., every frame). In certain embodiments, the aggregation filter processor 150 can integrate the various feeds into an estimate (e.g., a wholistic estimate). In some embodiments, the aggregation filter processor 150 implements a Kalman filter algorithm and/or a similar algorithm to synthesize estimates of the geo-coordinates (e.g., true geo-coordinates) based on the various observations provided by the other processors (e.g., the calibration processor 120, the optical flow processor 130, the reference georegistration processor 140, etc.). In certain embodiments, the georegistration system 100 is adapted to the variable availability of the different streams, including dropouts or missing processors, continuing to provide the estimate (e.g., best available estimate) and predicted confidence. In some embodiments, the aggregation filter processor 150 requires lightweight computational cost (e.g., a few milliseconds, a couple of milliseconds).

In certain embodiments, the georegistration system 100 includes a projection processor for projection. In some embodiments, the georegistration system 100 projects against a DEM (digital elevation model). In certain embodiments, the projection processor is a standalone processor. In some embodiments, the projection processor is a part of the reference georegistration processor 140 and/or a part of the aggregation filter processor 150.

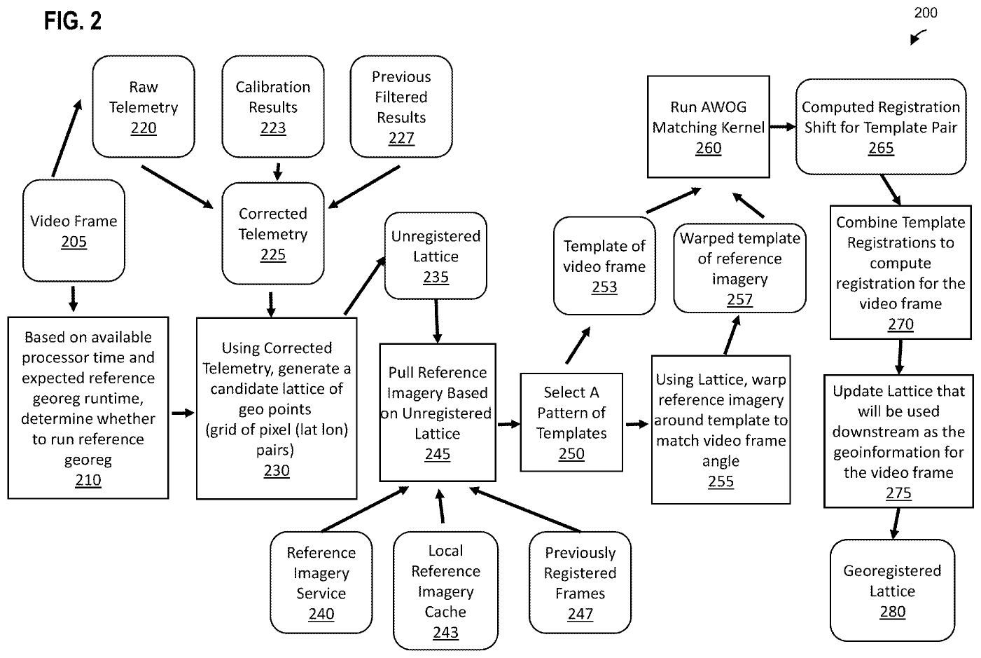

FIG. 2 is a simplified diagram showing a software architecture 200 for a video georegistration system according to certain embodiments of the present disclosure. This diagram is merely an example. One of ordinary skill in the art would recognize many variations, alternatives, and modifications. The architecture 200 for the video georegistration system includes components and processes 210, 220, 223, 225, 227, 230, 235, 240, 243, 245, 247, 250, 253, 255, 257, 260, 265, 270, 275 and 280. Although the above has been shown using a selected group of components and processes for the software architecture 200 for the video georegistration system, there can be many alternatives, modifications, and variations. For example, some of the components and/or processes may be expanded and/or combined. Other components and/or processes may be inserted into those noted above. Depending upon the embodiment, the sequence of processes may be interchanged with others replaced. Further details of these components and processes are found throughout the present disclosure.

According to some embodiments, the video georegistration system receives one or more videos or video streams including one or more video frames 205 (e.g., 30 frames-per-second (FPS), 60 FPS, etc.). In certain embodiments, at the process 210, the video georegistration system is configured to determine whether to run reference georegistration based on available processor time and expected reference georegistration runtime. In some embodiments, if the available processor time is lower than expected reference georegistration runtime, the video georegistration system does not perform the reference georegistration. In certain embodiments, if the available processor time is greater than expected reference georegistration runtime, the video georegistration system continues to perform the reference georegistration.

According to certain embodiments, the video georegistration system generates corrected telemetry 225 based on raw telemetry 220, calibrated results 223, and/or previous filtered results (e.g., Kalman filtered results) 227. In some embodiments, the raw telemetry 220 is extracted from the received video, the video stream and/or a video frame of the one or more video frames 205. In certain embodiments, the calibration is to essentially clean up the video telemetry on the basis of common failure modes. In some embodiments, the calibration includes interpolating missing frames (e.g., video frames) of the telemetry. Accordingly, in some embodiments, the calibrating includes interpolating missing video frames based on the telemetry data. In certain embodiments, the calibration includes lining up the video frames in case they came in staggered. In some embodiments, the calibration includes the ability to incorporate basically known corrections, such as previous filtered results 227. In certain embodiments, the calibration can correct some types of video feed exhibit systematic errors. In some examples, the systematic errors include an error in the field of view (e.g., the lens angle). For example, a lens angle of 5.1 degrees is actually 5.25 degrees, and such deviation can be used in calibration.

According to some embodiments, at the process 230, the video georegistration system generates a candidate lattice of geo points (e.g., grid of pixel (latitude, longitude) pairs) using corrected telemetry and generates unregistered lattice 235. In certain embodiments, at the process 245, the video georegistration system is configured to pull reference imagery based on unregistered lattice. In some embodiments, the video georegistration system uses reference imagery service 240, local reference imagery cache 243, and/or previously registered frames 247 to pull reference imagery. In certain embodiments, the video georegistration system can retrieve or generate reference imagery synchronously (e.g., within one hour) with the input video, for example, using the reference imagery service 240. In some embodiments, the video georegistration system can use local reference imagery cache 243 to retrieve reference imagery. In certain embodiments, the video georegistration system can use previously registered frames 247 (e.g., reference image used in previously registered frames).

According to certain embodiments, the reference imagery (e.g., reference image) can be generated based upon the geo-coordinates of the unregistered lattice. In some embodiments, the reference imagery is retrieved from the local reference imagery cache 243, for example, at the same edge device where at least a part of the video georegistration system is running on. In certain embodiments, the reference imagery is generated, stored, and/or retrieved from the same edge environment (e.g., on the physical plane). In some embodiments, the georegistration system avoids sending out requests for using, on high-latency connection. In certain embodiments, the georegistration system can use a pre-bundle set of tiles or shifted pre-bundle set of tiles as the reference imagery. In some embodiments, the georegistration system and/or another system support the generation (e.g., rapid generation) of localized base maps for reference imagery creation.

According to some embodiments, the georegistration system can couple a platform (e.g., a platform that harnesses satellite technology for autonomous decision making) with other available sources of satellite imagery to automatically pull the satellite images of an area (e.g., an area associated with the input video, an area associated with the video frame, an area associated with the unregistered lattice) and automatically build a base map in that area proximate in time (e.g., within four (4) hours, within one hour).

According to certain embodiments, at the process 250, the video georegistration system selects a pattern of templates and generates a template (e.g., a template slice) of the video frame 253. In some embodiments, at the process 255, the video georegistration system warps reference imagery around a template to match the video frame angle to generate a warped template (e.g., template slice) of reference imagery 257. In certain embodiments, at the process 260, the video georegistration system runs AWOG matching and/or other matching algorithm to the template and the warped template, also referred to as the template pair, to generates the computed registration shift for the template pair 265.

According to some embodiments, the video georegistration system recursively generates registrations for the templates. In certain embodiments, at the process 270, the video georegistration system combines template registrations to generate a frame registration (e.g., an image transform) for the video frame. In some embodiments, at the process 275, the video georegistration system updates the lattice using the frame registration to generate the georegistered lattice 280, which can be used downstream as the geoinformation for the video frame. In certain embodiments, the video georegistration system can use the frame registration to generate the georegistered video frame.

FIG. 3 is a simplified diagram showing a method 300 for video georegistration according to certain embodiments of the present disclosure. This diagram is merely an example. One of ordinary skill in the art would recognize many variations, alternatives, and modifications. The method 300 for sorting templates and/or generating a template queue includes processes 310, 315, 320, 325, 330, 335, and 340. Although the above has been shown using a selected group of processes for the method 300 for sorting templates and/or generating a template queue, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 300 are performed by a system (e.g., the computing system 600). In certain examples, some or all processes (e.g., steps) of the method 300 are performed by a computer and/or a processor directed by a code. For example, a computer includes a server computer and/or a client computer (e.g., a personal computer). In some examples, some or all processes (e.g., steps) of the method 300 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at the process 310, the georegistration system receives an input video including a plurality of video frames. In certain embodiments, at the process 315, the video georegistration system is configured to start a reference georegistration process to a video frame at a frame rate. In some embodiments, the frame rate is a fixed frame rate. In certain embodiments, the frame rate is a dynamic frame rate (e.g., not a fixed frame rate). In some embodiments, the video georegistration system determine whether to run reference georegistration based on available processor time and expected reference georegistration runtime. In some embodiments, if the available processor time is lower than expected reference georegistration runtime, the video georegistration system does not perform the reference georegistration. In certain embodiments, if the available processor time is greater than expected reference georegistration runtime, the video georegistration system continues to perform the reference georegistration.

According to certain embodiments, at the process 320, the video georegistration system identifies geoinformation associated with the video frame. In some embodiments, the video georegistration system generates corrected telemetry based on raw telemetry, calibrated results, and/or previous filtered results (e.g., Kalman filtered results). In some embodiments, the raw telemetry is extracted from the received video, the video stream and/or a video frame of the one or more video frames. In certain embodiments, the calibration is to essentially clean up the video telemetry on the basis of common failure modes. In some embodiments, the calibration includes interpolating missing frames of the telemetry. In certain embodiments, the calibration includes lining up the video frames in case they came in staggered. In some embodiments, the calibration includes the ability to incorporate basically known corrections, such as previous filtered results. In certain embodiments, the calibration can correct some types of video feed exhibit systematic errors.

According to some embodiments, the video georegistration system generates a candidate lattice of geo points (e.g., grid of pixel (latitude, longitude) pairs) using corrected telemetry and generates unregistered lattice. In certain embodiments, at the process 325, the video georegistration system is configured to generate or select a reference image based at least in part on the geoinformation associated with the video frame (e.g., unregistered lattice). In some embodiments, the video georegistration system uses reference imagery service, local reference imagery cache, and/or previously registered frames to pull reference imagery. In certain embodiments, the video georegistration system can retrieve or generate reference imagery synchronously (e.g., within one hour) with the input video, for example, using the reference imagery service. In some embodiments, the video georegistration system can use local reference imagery cache to retrieve reference imagery. In certain embodiments, the video georegistration system can use previously registered frames (e.g., reference imagery used in previously registered frames). In some embodiments, the video georegistration system can combine multiple images to generate the reference image.

According to certain embodiments, the reference image can be generated based upon the geo-coordinates of the unregistered lattice. In some embodiments, the reference imagery is retrieved from the local reference imagery cache, for example, at the same edge device where at least a part of the video georegistration system is running on. In certain embodiments, the reference image is generated, stored, and/or retrieved from the same edge environment (e.g., on the physical plane). In some embodiments, the georegistration system avoids sending out requests for using, on high-latency connection. In certain embodiments, the georegistration system can use a pre-bundle set of tiles or shifted pre-bundle set of tiles as the reference imagery. In some embodiments, the georegistration system and/or another system support the generation (e.g., rapid generation) of localized base maps for reference imagery creation.

According to some embodiments, the georegistration system can couple with a device constellation platform (e.g., a meta-constellation platform) with other available sources of satellite imagery to automatically pull the satellite images of an area (e.g., an area associated with the input vide, an area associated with the video frame, an area associated with the unregistered lattice) and automatically build a base map in that area proximate in time (e.g., within four (4) hours, within one hour). In certain embodiments, a device constellation platform is for one or more constellations of edge devices.

According to certain embodiments, at the process 330, the video georegistration system generates a georegistration transform based at least in part on the reference image. In some embodiments, the video georegistration system selects a pattern of templates and generates a template (e.g., a template slice) of the video frame. In some embodiments, the video georegistration system warps reference imagery around a template to match the video frame angle to generate a warped template (e.g., template slice) of reference imagery. In certain embodiments, the video georegistration system runs AWOG matching and/or other matching algorithm to the template and the warped template, also referred to as the template pair, to generates the computed registration shift for the template pair.

According to some embodiments, the video georegistration system recursively generates registrations for the templates. In certain embodiments, the video georegistration system combines template registrations to generate a frame registration (e.g., an image transform) for the video frame. In some embodiments, the video georegistration system updates the lattice using the frame registration to generate the georegistered lattice, which can be used downstream as the geoinformation for the video frame.

According to certain embodiments, at the process 335, the video georegistration system applies the georegistration transform to the video frame to generate the registered video frame (e.g., the georegistered video frame). In some embodiments, at the process 340, the video georegistration system outputs the registered video frame. In certain embodiments, the video georegistration system recursively conducts steps 315-340 to continuously generate georegistered video frames and/or georegistered videos.

FIG. 4 is a simplified diagram showing a method 400 for generating a transformation (e.g., an image transformation) according to certain embodiments of the present disclosure. This diagram is merely an example. One of ordinary skill in the art would recognize many variations, alternatives, and modifications. The method 400 for generating a transformation (e.g., an image transformation) includes processes 410, 415, 420, 425, 430, 435, and 440. Although the above has been shown using a selected group of processes for the method 400 for generating a transformation (e.g., an image transformation), there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 400 are performed by a system (e.g., the computing system 600). In certain examples, some or all processes (e.g., steps) of the method 400 are performed by a computer and/or a processor directed by a code. For example, a computer includes a server computer and/or a client computer (e.g., a personal computer). In some examples, some or all processes (e.g., steps) of the method 400 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at the process 410, the georegistration system conducts image transformation computation for N iterations. In some embodiments, the georegistration system conducts image transformation computation with iterations. In certain embodiments, at the process 415, the georegistration system selects a number of points (e.g., 3 points) at random, at the process 420, the georegistration system computes a transform matching the selected points. In some embodiments, the georegistration system selects a predetermined number of points at random and computes the transform (e.g., affine transform) matching those selected points. In certain embodiments, the georegistration system selects one point for a translation.

According to some embodiments, at the process 425, the georegistration system applies a nonlinear algorithm (e.g., a Levenberg-Marquardt nonlinear algorithm) to determine an error associated with the transform. In certain embodiments, the georegistration system applies the nonlinear algorithm to the sum of the distances (e.g., Lorentz distances) between every point's shift value (e.g., preferred shift value). In certain embodiments, each point's shift value is weighted by each point's strength value in determining the error.

According to certain embodiments, at the process 430, if the error is lower than all previous transform, the transform is designated as a candidate transform (e.g., best candidate). In some embodiments, at the process 435, the georegistration system determines whether the N iterations have been completed. In certain embodiments, the georegistration system goes back to the process 410 if the N iterations have not been completed. In some embodiments, the georegistration system goes to the process 440 if the N iterations have been completed. In certain embodiments, at the process 440, the georegistration system returns the candidate transform (e.g., the best candidate transform).

FIG. 5 is an illustrative example of a video georegistration environment 500, according to certain embodiments of the present disclosure. FIG. 5 is merely an example. One of the ordinary skilled in the art would recognize many variations, alternatives, and modifications. According to certain embodiments, the georegistration environment 500 includes a georegistration system 510 and one or more imaging systems 540 (e.g., imaging system 540A, imaging system 540B, . . . , imaging system 540N). According to some embodiments, the georegistration system 510 includes one or more processors 520 for video georegistration and one or more memories 530, also refers to as a repository 530. In certain embodiments, the repository 530 includes one or more reference imagery sources 532 for storing data (e.g., reference images). In some embodiments, the repository 530 can be accessed by the one or more imaging systems 540. In certain embodiments, some or all of the imaging systems 540 includes or is integrated with a video georegistration system 510. Although the above has been shown using a selected group of components in the georegistration environment 500, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

According to certain embodiments, the video georegistration system 500 and/or the processor 520 receives an input video including a plurality of video frames. In certain embodiments, the video georegistration system 500 and/or the processor 520 is configured to start a reference georegistration process to a video frame at a frame rate. In some embodiments, the frame rate is a fixed frame rate. In certain embodiments, the frame rate is a dynamic frame rate (e.g., not a fixed frame rate). In some embodiments, the video georegistration system 500 and/or the processor 520 determine whether to run reference georegistration based on available processor time and expected reference georegistration runtime. In some embodiments, if the available processor time is lower than expected reference georegistration runtime, the video georegistration system 500 and/or the processor 520 does not perform the reference georegistration. In certain embodiments, if the available processor time is greater than expected reference georegistration runtime, the video georegistration system 500 and/or the processor 520 continues to perform the reference georegistration.

According to certain embodiments, the video georegistration system 500 and/or the processor 520 identifies geoinformation associated with the video frame. In some embodiments, the video georegistration system generates corrected telemetry based on raw telemetry, calibrated results, and/or previous filtered results (e.g., Kalman filtered results). In some embodiments, the raw telemetry is extracted from the received video, the video stream and/or a video frame of the one or more video frames. In certain embodiments, the calibration is to essentially clean up the video telemetry on the basis of common failure modes. In some embodiments, the calibration includes interpolating missing frames of the telemetry. In certain embodiments, the calibration includes lining up the video frames in case they came in staggered. In some embodiments, the calibration includes the ability to incorporate basically known corrections, such as previous filtered results. In certain embodiments, the calibration can correct some types of video feed exhibit systematic errors.

According to some embodiments, the video georegistration system generates a candidate lattice of geo points (e.g., grid of pixel (latitude, longitude) pairs) using corrected telemetry and generates unregistered lattice. In certain embodiments, the video georegistration system is configured to generate or select a reference image based at least in part on the geoinformation associated with the video frame (e.g., unregistered lattice). In some embodiments, the video georegistration system uses reference imagery service, local reference imagery cache, and/or previously registered frames to pull reference imagery. In certain embodiments, the video georegistration system can retrieve or generate reference imagery synchronously (e.g., within one hour) with the input video, for example, using the reference imagery service. In some embodiments, the video georegistration system can use local reference imagery cache to retrieve reference imagery. In certain embodiments, the video georegistration system can use previously registered frames (e.g., reference imagery used in previously registered frames). In some embodiments, the video georegistration system can combine multiple images to generate the reference image.

According to certain embodiments, the reference image can be generated based upon the geo-coordinates of the unregistered lattice. In some embodiments, the reference imagery is retrieved from the local reference imagery cache, for example, at the same edge device where at least a part of the video georegistration system 500 and/or the processor 520 is running on. In certain embodiments, the reference image is generated, stored, and/or retrieved from the same edge environment (e.g., on the physical plane). In some embodiments, the georegistration system avoids sending out requests for using, on high-latency connection. In certain embodiments, the georegistration system can use a pre-bundle set of tiles or shifted pre-bundle set of tiles as the reference imagery. In some embodiments, the georegistration system and/or another system support the generation (e.g., rapid generation) of localized base maps for reference imagery creation.

According to some embodiments, the georegistration system can couple with a device constellation platform (e.g., a meta-constellation platform) with other available sources of satellite imagery to automatically pull the satellite images of an area (e.g., an area associated with the input vide, an area associated with the video frame, an area associated with the unregistered lattice) and automatically build a base map in that area proximate in time (e.g., within four (4) hours, within one hour). In certain embodiments, a device constellation platform is for one or more constellations of edge devices.

According to certain embodiments, the video georegistration system 500 and/or the processor 520 generates a georegistration transform based at least in part on the reference image. In some embodiments, the video georegistration system 500 and/or the processor 520 selects a pattern of templates and generates a template (e.g., a template slice) of the video frame. In some embodiments, the video georegistration system 500 and/or the processor 520 warps reference imagery around a template to match the video frame angle to generate a warped template (e.g., template slice) of reference imagery. In certain embodiments, the video georegistration system 500 and/or the processor 520 runs AWOG matching and/or other matching algorithm to the template and the warped template, also referred to as the template pair, to generates the computed registration shift for the template pair.

According to some embodiments, the video georegistration system 500 and/or the processor 520 recursively generates registrations for the templates. In certain embodiments, the video georegistration system 500 and/or the processor 520 combines template registrations to generate a frame registration (e.g., an image transform) for the video frame. In some embodiments, the video georegistration system 500 and/or the processor 520 updates the lattice using the frame registration to generate the georegistered lattice, which can be used downstream as the geoinformation for the video frame.

According to certain embodiments, the video georegistration system 500 and/or the processor 520 applies the georegistration transform to the video frame to generate the registered video frame (e.g., the georegistered video frame). In some embodiments, the video georegistration system 500 and/or the processor 520 outputs the registered video frame. In certain embodiments, the video georegistration system 500 and/or the processor 520 recursively conducts steps 315-340 to continuously generate georegistered video frames and/or georegistered videos.

In some embodiments, the repository 530 can include software instructions, input images, reference images, registered images, templates in images, scores associated with templates, image transforms, transformations, template queues, and/or the like. The repository 530 may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the video georegistration environment 500 can execute software or firmware stored in non-transitory computer-readable medium to implement various processing steps. Various components and processors of the video georegistration environment 500 can be implemented by one or more computing devices including, but not limited to, circuits, a computer, a cloud-based processing unit, a processor, a processing unit, a microprocessor, a mobile computing device, and/or a tablet computer. In some cases, various components of the georegistration environment 500 (e.g., the georegistration system 510, the imaging systems 540) can be implemented on a shared computing device. Alternatively, a component of the video georegistration environment 500 can be implemented on multiple computing devices. In some implementations, various modules and components of the video georegistration environment 500 can be implemented as software, hardware, firmware, or a combination thereof. In some cases, various components of the georegistration environment 500 can be implemented in software or firmware executed by a computing device.

Various components of the georegistration environment 500 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

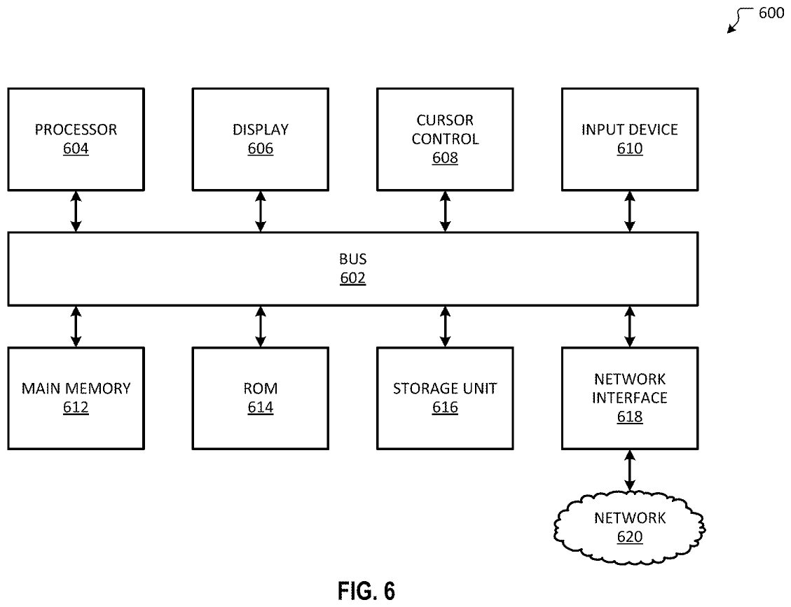

FIG. 6 is a simplified diagram showing a computing system for implementing a system 600 for video georegistration in accordance with at least one example set forth in the disclosure. This diagram is merely an example, which should not unduly limit the scope of the claims. One of ordinary skill in the art would recognize many variations, alternatives, and modifications.

The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of the methods 300, and/or 400 are performed by the computing system 600. In some examples, the bus 602 is coupled to the processor 604, the display 606, the cursor control component 608, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For examples, the instructions, when stored in the storage unit 616 accessible to processor 604, render the computing system 600 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to certain embodiments, a method for video georegistration is provided. The method comprises: receiving an input video including a plurality of video frames; calibrating a first set of video frames selected from the plurality of video frames to generate a first set of calibrated video frames using a calibration transform; performing one or more reference georegistrations to a second set of video frames selected from the plurality of video frames to generate a video georegistration transform using the second set of video frames, the second set of video frames having fewer video frames than the first set of video frames; generating an output video using the calibration transform and the video georegistration transform; wherein the method is performed using one or more processors. For example, the method is implemented according to at least FIG. 1, FIG. 2, FIG. 3, and/or FIG. 5.

In some embodiments, the video transform includes one or more video frame transforms corresponding to the second set of video frames. In certain embodiments, the method further comprises: applying an optical flow estimation to a third set of video frames of the plurality of the video frames; wherein the third set of video frames has fewer video frames than the first set of video frames and more video frames than the second set of video frames.

In some embodiments, the calibrating is processed at a first frame rate. In some embodiments, the performing one or more reference georegistrations is processed at a second frame rate that is different than the first frame rate. In some embodiments, the calibrating is performed based on historical telemetry data. In some embodiments, telemetry data is extracted from the plurality of video frames, and the calibrating comprises interpolating missing video frames from the plurality of video frames based on the telemetry data. In some embodiments, the input video includes satellite imagery.

According to some embodiments, a method for video georegistration is provided. The method comprises: receiving an input video including a plurality of video frames; performing one or more reference georegistrations using one or more corresponding reference images at a dynamic frame rate; wherein the method is performed using one or more processors. For example, the method is implemented according to at least FIG. 1, FIG. 2, FIG. 3, and/or FIG. 5.

In certain embodiments, the performing one or more reference georegistrations using one or more corresponding reference images at a dynamic frame rate comprises: performing one or more reference georegistrations at a first frame rate at a first time; performing one or more reference georegistrations at a second frame rate at a second time; wherein the second frame rate is different from the first frame rate. In some embodiments, the performing one or more reference georegistrations using one or more corresponding reference images at a dynamic frame rate comprises: determining an available processing time; estimating an expected reference georegistration runtime; and performing one reference georegistration of the one or more reference georegistrations if the available processing time is greater than the expected reference georegistration runtime. In certain embodiments, at least one reference image of the one or more reference images is generated based upon a plurality of images. In some embodiments, at least one reference image of the one or more reference images is selected by searching in an area associated with a corresponding video frame.

According to some embodiments, a system for video georegistration is provided. The system includes one or more processors and one or more memories storing instructions that, when executed by the processor, cause the system to perform a set of operations. The set of operations include: receiving an input video including a plurality of video frames; calibrating a first set of video frames selected from the plurality of video frames to generate a first set of calibrated video frames using a calibration transform; performing one or more reference georegistrations to a second set of video frames selected from the plurality of video frames to generate a video georegistration transform using the second set of video frames, the second set of video frames having fewer video frames than the first set of video frames; generating an output video using the calibration transform and the video georegistration transform; wherein the method is performed using one or more processors. For example, the set of operations is implemented according to at least FIG. 1, FIG. 2, FIG. 3, and/or FIG. 5.

In some embodiments, the video transform includes one or more video frame transforms corresponding to the second set of video frames. In certain embodiments, the set of operations further comprises: applying an optical flow estimation to a third set of video frames of the plurality of the video frames; wherein the third set of video frames has fewer video frames than the first set of video frames and more video frames than the second set of video frames.

In some embodiments, the calibrating is processed at a first frame rate. In some embodiments, the performing one or more reference georegistrations is processed at a second frame rate that is different than the first frame rate. In some embodiments, the calibrating is performed based on historical telemetry data. In some embodiments, telemetry data is extracted from the plurality of video frames, and the calibrating comprises interpolating missing video frames from the plurality of video frames based on the telemetry data. In some embodiments, the input video includes satellite imagery.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for video georegistration, the method comprising:
receiving an input video including a plurality of video frames;
calibrating a first set of video frames selected from the plurality of video frames to generate a first set of calibrated video frames using a calibration transform;
performing one or more reference georegistrations to a second set of video frames selected from the plurality of video frames to generate a video georegistration transform using the second set of video frames, the second set of video frames having fewer video frames than the first set of video frames; and
generating an output video using the calibration transform and the video georegistration transform,
wherein the method is performed using one or more processors.

2. The method of claim 1, wherein the video transform includes one or more video frame transforms corresponding to the second set of video frames.

3. The method of claim 1, further comprising:
applying an optical flow estimation to a third set of video frames of the plurality of the video frames,
wherein the third set of video frames has fewer video frames than the first set of video frames and more video frames than the second set of video frames.

4. The method of claim 1, wherein the calibrating is processed at a first frame rate.

5. The method of claim 4, wherein the performing one or more reference georegistrations is processed at a second frame rate that is different than the first frame rate.

6. The method of claim 1, wherein the calibrating is performed based on historical telemetry data.

7. The method of claim 1, wherein telemetry data is extracted from the plurality of video frames, and the calibrating comprises interpolating missing video frames from the plurality of video frames based on the telemetry data.

8. The method of claim 1, wherein the input video comprises satellite imagery.

9. A method for video georegistration, the method comprising:
receiving an input video including a plurality of video frames; and
performing one or more reference georegistrations using one or more corresponding reference images at a dynamic frame rate,
wherein the method is performed using one or more processors.

10. The method of claim 9, wherein the performing one or more reference georegistrations using one or more corresponding reference images at a dynamic frame rate comprises:
performing one or more reference georegistrations at a first frame rate at a first time; and
performing one or more reference georegistrations at a second frame rate at a second time,
wherein the second frame rate is different from the first frame rate.

11. The method of claim 9, wherein the performing one or more reference georegistrations using one or more corresponding reference images at a dynamic frame rate comprises:
determining an available processing time;
estimating an expected reference georegistration runtime; and
performing one reference georegistration of the one or more reference georegistrations if the available processing time is greater than the expected reference georegistration runtime.

12. The method of claim 9, wherein at least one reference image of the one or more reference images is generated based upon a plurality of images.

13. The method of claim 9, wherein at least one reference image of the one or more reference images is selected by searching in an area associated with a corresponding video frame.

14. A system for video georegistration, the system comprising:
one or more processors; and
one or more memories storing instructions that, when executed by the one or more processors, cause the system to perform a set of operations, the set of operations comprising:
receiving an input video including a plurality of video frames;
calibrating a first set of video frames selected from the plurality of video frames to generate a first set of calibrated video frames using a calibration transform;
performing one or more reference georegistrations to a second set of video frames selected from the plurality of video frames to generate a video georegistration transform using the second set of video frames, the second set of video frames having fewer video frames than the first set of video frames; and
generating an output video using the calibration transform and the video georegistration transform.

15. The system of claim 14, wherein the video transform includes one or more video frame transforms corresponding to the second set of video frames.

16. The system of claim 14, the set of operations further comprising:
applying an optical flow estimation to a third set of video frames of the plurality of the video frames,
wherein the third set of video frames has fewer video frames than the first set of video frames and more video frames than the second set of video frames.

17. The system of claim 14, wherein the calibrating is processed at a first frame rate.

18. The system of claim 17, wherein the performing one or more reference georegistrations is processed at a second frame rate that is different than the first frame rate.

19. The system of claim 14, wherein the calibrating is performed based on historical telemetry data.

20. The system of claim 14, wherein telemetry data is extracted from the plurality of video frames, and wherein the calibrating comprises interpolating missing video frames from the plurality of video frames based on the telemetry data.
